(19) United States
(12) Patent Application Publication
(10) Pub. No.: US 2012/0207940 A1
(43) Pub. Date: Aug. 16, 2012

(54) PATTERN FORMING METHOD AND PATTERN FORMING DEVICE

(75) Inventors: Makoto MURAMATSU, Nirasaki City (JP); Yuriko SEINO, Yokohama-City (JP)

(73) Assignees: TOKYO ELECTRON LIMITED, Tokyo (JP); KABUSHIKI KAISHA TOSHIBA, Tokyo (JP)

(21) Appl. No.: 13/372,981

(22) Filed: Feb. 14, 2012

(30) Foreign Application Priority Data
Feb. 14, 2011 (JP) 2011-29138

(51) Int. Cl. C08J 7/18; C08J 7/04

(52) U.S. Cl. 427/510; 118/620

(57) ABSTRACT

A pattern forming method includes: forming a layer of a block copolymer, including at least two kinds of polymers, on a substrate; heating the block copolymer layer; irradiating UV light on the heated block copolymer layer; and supplying a developing solution to the UV light-irradiated block copolymer layer.

### CROSS-REFERENCE TO RELATED APPLICATION

This application claims the benefit of Japanese Patent Application No. 2011-029138, filed on Feb. 14, 2011, in the Japan Patent Office, the disclosure of which is incorporated herein in its entirety by reference.

### TECHNICAL FIELD

The present disclosure relates to a Directed Self Assembly (DSA) lithography technology, and to a pattern forming method, a pattern forming device, and a semiconductor device forming method using the same.

### BACKGROUND

Recently, as Large Scale Integrated (LSI) circuits have become highly integrated progressively, for example, the realization of a line width such as 16 nm is required. For this realization, for example, using an extreme ultraviolet (EUV) exposure device using EUV light with a wavelength of 13.5 nm has been considered, but the EUV exposure device has not yet been used practically. Further, even though the EUV exposure device may become used practically, the cost would increase considerably.

Therefore, a DSA lithography technology that does not require the exposure device, and uses a block copolymer has been widely researched. In the DSA lithography technology, for example, a block copolymer of which an A polymer chain and a B polymer chain are bound to each other at tips thereof is first applied on a substrate. Subsequently, by heating the substrate, the A polymer chain and the B polymer chain, which are solidified at random, are phase-separated from each other, and an A polymer region and a B polymer region are arranged repeatedly. Then, by removing either the A polymer region or the B polymer region and patterning the block copolymer, a mask having a desired pattern is formed.

In patterning a block copolymer, for example, oxygen plasma may be used. The speed at which an A polymer chain and a B polymer chain are removed (carbonized) by oxygen plasma varies according to the chemical properties of the A polymer chain and B polymer chain (having a certain selectivity), and thus, by applying the oxygen plasma onto the block copolymer, one of the A polymer chain and the B polymer chain can be removed.

However, since both the A polymer chain and the B polymer chain are organic materials, a high selectivity is difficult to achieve. For example, in a block copolymer [poly(styrene-block-methyl methacrylate): PS-b-PMMA] whose A polymer chain is polystyrene (PS) and B polymer chain is polymethyl methacrylate (PMMA), the selectivity of PS:PMMA is no more than 1:2.

Moreover, since a PS region and a PMMA region are regularly arranged by heat treatment when the thickness of the block copolymer does not exceed twice the width of the respective regions, in order to arrange PS and PMMA at a region width of, for example, about 15 nm, the block copolymer applied onto the substrate inevitably needs to have a thickness of about 30 nm. When the PMMA region of the block copolymer having a thickness of about 30 nm is removed by oxygen plasma, the thickness of the PS region left on the substrate is no more than about 15 nm. With this, the PS region having a regular pattern cannot be used as an etching mask.

In addition, a patterning method using no oxygen plasma has also been proposed. For example, a method that irradiates an energy ray such as an electron ray, γ ray, or X ray on a block copolymer applied onto a substrate and rinses the irradiated block copolymer with an aqueous solvent or an organic solvent has been studied. This method uses the property that a main chain of PMMA is cut and easily dissolved by an organic solvent when an energy ray is irradiated on phase-separated PS-b-PMMA. Further, a method that irradiates UV light on PS-b-PMMA and removes the PMMA with acetic acid has also been proposed.

However, a large-scale device is required to irradiate an energy ray on a substrate, and, for example, when using an acid such as acetic acid, new supply equipment is required for supplying the acid.

### SUMMARY

The present disclosure provides a pattern forming method and a pattern forming device that can easily form a pattern with a block copolymer.

According to one embodiment of the present disclosure, a pattern forming method includes: forming a layer of a block copolymer, including at least two kinds of polymers, on a substrate; heating the block copolymer layer; irradiating UV light on the heated block copolymer layer; and supplying a developing solution to the UV light-irradiated block copolymer layer.

According to another embodiment of the present disclosure, provided is a pattern forming device including: a substrate rotation part configured to support a substrate and rotate; a coating solution supply part configured to supply a coating solution, including a block copolymer, to the substrate supported by the substrate rotation part; a heating part configured to heat the substrate on which a layer of the block copolymer is formed; a light source configured to irradiate UV light on the heated block copolymer layer; a developing solution supply part configured to supply a developing solution to the UV light-irradiated block copolymer layer.

According to another embodiment of the present disclosure, provided is a pattern forming method that includes: patterning a photoresist layer formed of an electron ray photoresist, and forming a plurality of first lines formed of the electron ray photoresist; filling a space between the first lines with a layer of a block copolymer including at least two kinds of polymers; heating the block copolymer layer; irradiating UV light on the heated block copolymer layer; and supplying a developing solution to the UV light-irradiated block copolymer layer.

### BRIEF DESCRIPTION OF THE DRAWINGS

The accompanying drawings, which are incorporated in and constitute a part of the specification, illustrate embodiments of the present disclosure, and together with the general description given above and the detailed description of the embodiments given below, serve to explain the principles of the present disclosure.

FIGS. 1A to 1E are views for describing a pattern forming method according to a first aspect of the present disclosure.

FIGS. 2A to 2C are views for describing the principle of the pattern forming method according to the first aspect of the present disclosure.

FIGS. 3A to 3C are views for describing a first embodiment of the pattern forming method according to the first aspect of the present disclosure.

FIGS. 4A and 4B are views for describing a second embodiment of the pattern forming method according to the first aspect of the present disclosure.

FIGS. 5A to 5C are views for describing a pattern forming method according to a second aspect of the present disclosure.

FIGS. 6A to 6C are additional views for describing the pattern forming method according to the second aspect of the present disclosure.

FIG. 7 is a perspective view schematically illustrating a pattern forming device according to a third aspect of the present disclosure.

FIG. 8 is a schematic top view illustrating the pattern forming device according to the third aspect of the present disclosure.

FIG. 9 is a schematic perspective view illustrating the inside of a processing station of the pattern forming device of FIGS. 7 and 8.

FIG. 10 is a schematic perspective view illustrating an application unit of the pattern forming device of FIGS. 7 and 8.

FIG. 11 is a view for describing a UV irradiation unit of the pattern forming device of FIGS. 7 and 8.

FIG. 12 is a schematic top view illustrating a susceptor of the UV irradiation unit of FIG. 11.

FIG. 13 is a view for describing a modified embodiment of the UV irradiation unit of FIG. 11.

FIGS. 14A to 14F are electron microscope images showing the dependency of a pattern shape on a dose of UV light in the pattern forming method according to an aspect of the present disclosure.

### DETAILED DESCRIPTION

Hereinafter, embodiments of the present disclosure will now be described in detail with reference to the accompanying drawings. In the accompanying drawings, the same or equal elements/members are indicated by the same reference numerals, and a repetitive description is not provided.

### <First Aspect>

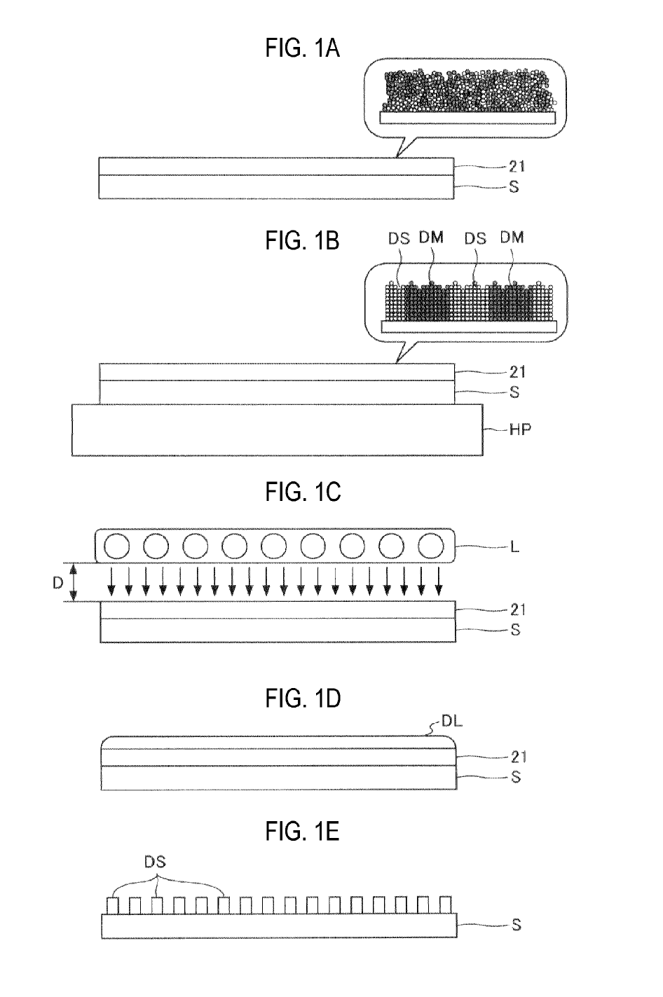

Referring to FIGS. 1A to 4B, a pattern forming method according to a first aspect of the present disclosure will now be described. In this method, a solution (hereinafter referred to as a coating solution) that is produced by dissolving a polystyrene (PS) polymethyl methacrylate (PMMA) block copolymer (hereinafter referred to as PS-b-PMMA) in an organic solvent is prepared. Materials having high mutual solubility with the PS and PMMA constituting the PS-b-PMMA, for example, toluene, propylene glycol-monomethyl ether acetate (PGMEA) or the like may be used as an organic solvent without particular limitation.

Subsequently, by applying the coating solution onto a substrate S, for example, in a spin coating process, as illustrated in FIG. 1A, a layer 21 of PS-b-PMMA is formed. In the layer 21, as schematically illustrated in the inserted view of FIG. 1A, a PS polymer and a PMMA polymer are mixed with each other.

As illustrated in FIG. 1B, the substrate S with the PS-b-PMMA layer 21 formed thereon is disposed on a heater plate HP and heated at a certain temperature, such that the PS-b-PMMA is phase-separated. Therefore, as illustrated in the inserted view of FIG. 1B, a PS region DS and a PMMA region DM are alternately arranged. Herein, the width of the PS region DS is determined as an integer multiple of the molecular length of PS, and the width of the PMMA region DM is determined as an integer multiple of the molecular length of PMMA. Thus, in the PS-b-PMMA layer 21, the PS region DS and the PMMA region DM are repeatedly arranged at equal pitches (width of the region DS+width of the region DM). In addition, the width of the PS region DS is determined by the number of polymerizations of PS molecules, and the width of the PMMA region DM is determined by the number of polymerizations of PMMA molecules. Therefore, by adjusting the number of polymerizations, a desired pattern can be achieved.

After heating is ended, as illustrated in FIG. 1C, UV light is irradiated on the PS-b-PMMA layer 21 disposed on the substrate S, in the atmosphere. A light source that emits light having a wavelength in the UV region, for example, a low-pressure UV lamp (low-pressure mercury lamp) that emits UV light having a strong peak in a wavelength of 185 nm and wavelength of 254 nm, a Xe excimer lamp that emits single-wavelength light having a wavelength of 172 nm, or a KrCl excimer lamp that emits single-wavelength light having a wavelength of 222 nm may be used as a light source L for UV light without particular limitation. Further, using the Xe excimer lamp and the KrCl excimer lamp, UV light having a wavelength of 172 nm and UV light having a wavelength of 222 nm may be irradiated on the PS-b-PMMA layer 21 simultaneously or alternately. Moreover, in consideration of the light absorptiveness of PS-b-PMMA, UV light in an absorbing wavelength region may be irradiated on the PS-b-PMMA layer 21. In order to obtain such UV light, for example, a lamp that has a broad light emitting spectrum ranging from a far-UV region to a vacuum UV region, and a wavelength cutoff filter that blocks wavelengths longer than a wavelength of about 230 nm may be used. When UV light is irradiated, the PMMA may be oxidized by the UV light and the oxygen and/or water in the atmosphere, and thus, the solubility in a developing solution may increase.

Subsequently, as illustrated in FIG. 1D, a developing solution DL is applied onto the PS-b-PMMA layer 21. In a photolithography technology, a developing solution that is used to develop an exposed photoresist layer, for example, tetramethyl ammonium hydroxide (TMAH), may be used as the developing solution DL. Since PMMA oxidized by UV light has solubility in a developing solution, the PMMA is selectively dissolved in the developing solution DL.

Moreover, in FIG. 1D, since the developing solution DL is supplied to the layer 21 with the substrate S being stopped, the supplied developing solution DL remains on the layer 21 by surface tension. As another example, the developing solution DL may be supplied with the substrate S being rotated. However, when the developing solution DL is supplied with the substrate S being rotated, the developing solution DL flows toward an outer circumference of the substrate S, and thus, the PS region DS may washed away due to this flow (should not be dissolved in the developing solution DL and should remain). Accordingly, it is preferable to supply the developing solution DL with the substrate S being stopped.

After a certain time elapses, the developing solution DL is rinsed out with a rinsing solution and the surface of the substrate S is dried, and, as illustrated in FIG. 1E, a pattern configured with the PS region DS is formed. Herein, for example, deionized water (DIW) may be used as the rinsing solution, but, in order for the PS region DS not to fall down during drying, it is preferable to use liquid having a surface tension less than that of DIW. As such a liquid, it may be an alcohol (for example, methyl alcohol, ethanol, isopropyl alcohol (IPA), etc.) or an interface activator.

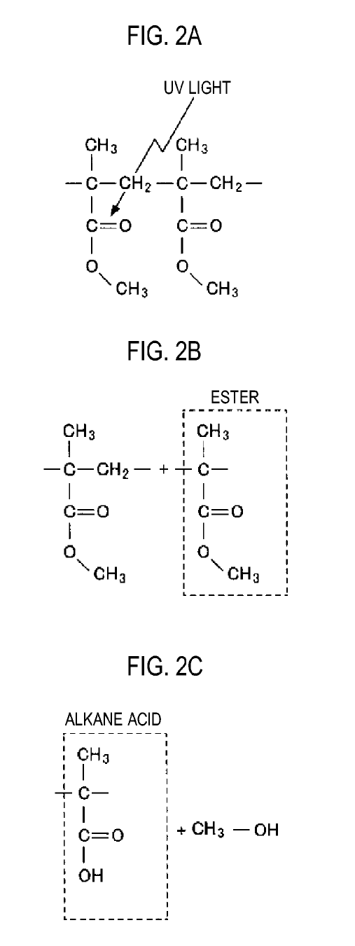

As illustrated in FIG. 2A, a PMMA polymer has a “—CH₂C(CH₃)(COOCH₃)—”-polymerized structure where a carbon (C) atom between a carboxyl group (—COOH) and a methyl group (—CH₃) is chemically bound to a C atom of a methylene group (—CH₂—). Herein, when UV light is irradiated, energy of the UV light acts on a ketone group (>C═O), and, as illustrated in FIG. 2B, the chemical bond between the C atoms is broken, thereby producing alkane acid ester. During developing, alkane acid ester is hydrolyzed with H₂O included in the developing solution such that alkane acid is produced (see FIG. 2C). Since the alkane acid is dissolved in TMAH, the PMMA polymer is removed by the TMAH. Meanwhile, since the PS in the PS-b-PMMA does not have a ketone group and esterification is not performed, even by an exposure, the PS is not dissolved in the TMAH. Due to these reasons, the PMMA is considered as being selectively removed. Therefore, in the pattern forming method according to an aspect of the present disclosure, it is preferable to use a block copolymer that consists of an A polymer having no ketone group and a B polymer having a ketone group.

Hereinafter, the pattern forming method according to an aspect of the present disclosure will be described with reference to embodiments of the present disclosure. Additionally, in the following description, according to a conventional photolithography technology (using a photoresist, a photomask, etc.), the irradiation of UV light on the PS-b-PMMA layer may be referred as an exposure, and patterning with a developing solution may be referred as a development.

### First Embodiment

First, a PS-b-PMMA coating solution is prepared. For example, toluene is used as a solvent, and the coating solution is produced by dissolving PS-b-PMMA in the solvent. A solid component concentration of PS-b-PMMA in the coating solution is about 2% volume. A spin coater applies the coating solution onto the substrate S, thereby forming the PS-b-PMMA layer (having a thickness of about 60 nm) on the substrate.

The substrate S with the PS-b-PMMA layer formed thereon is heated on a hot plate at a temperature of about 240 degrees C. for about 2 min. and chilled, and then UV light is irradiated on the PS-b-PMMA layer using a low-pressure mercury lamp for about 15 min. In this case, the irradiation intensity (dose) of the UV light is about 5.4 J/cm² in a peak of a wavelength of 254 nm of the UV light from the low-pressure mercury lamp. Since the intensity of a peak of a wavelength of 185 nm of the UV light from the low-pressure mercury lamp is one-hundredth of the intensity of the peak of a wavelength of 254 nm, a dose in the peak of a wavelength of 185 nm is about 54 mJ/cm². The distance D between the low-pressure mercury lamp and the substrate (PS-b-PMMA layer) is about 17 mm (see FIG. 1C).

After the exposure, TMAH (2.38%) is dripped onto the substrate with the PS-b-PMMA layer formed thereon, and the TMAH is left on the PS-b-PMMA layer for about 20 sec. Thereafter, the TMAH is rinsed, and the surface of the substrate S is cleaned with IPA and dried.

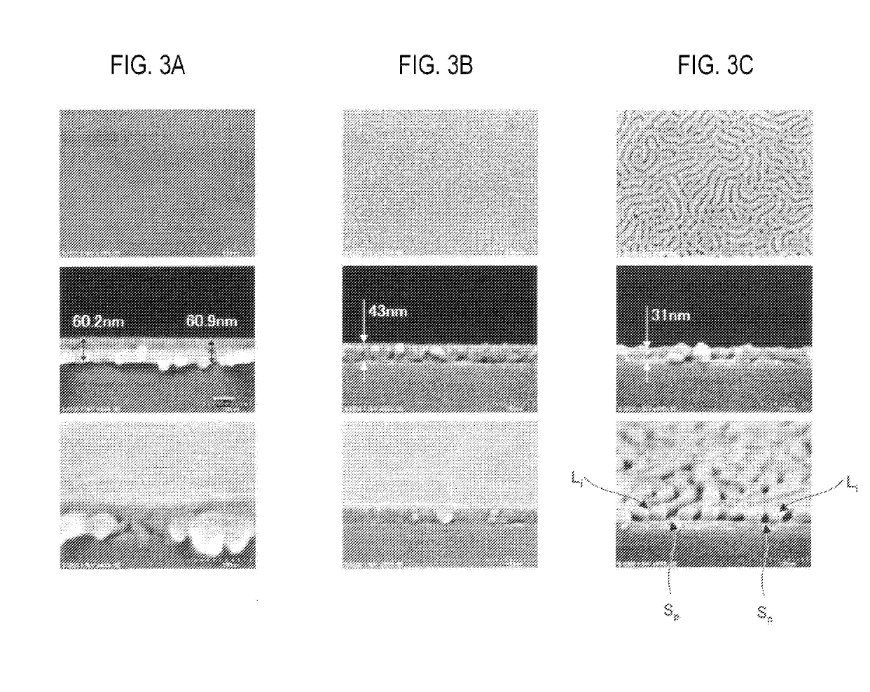

FIGS. 3A to 3C show the results obtained by observing a sample acquired through the above-described process with a Scanning Electron Microscope (SEM). FIG. 3A shows an SEM image of the PS-b-PMMA layer after the application. FIG. 3B shows an SEM image of the PS-b-PMMA layer after the exposure. FIG. 3C shows an SEM image of the PS-b-PMMA layer after the development. Further, in each of FIGS. 3A to 3C, a surface image, a side image, and a perspective image are shown in a direction from an upper side to a lower side.

Referring to the surface image of FIG. 3A, after the application, the PS-b-PMMA layer 21 shows the same surface morphology. However, after the exposure, as in the surface image of FIG. 3B, a fingerprint-shaped pattern is shown. As seen in surface image of FIG. 3C, the PMMA is removed after the development, and thus, the fingerprint-shaped pattern is clearly observed. Moreover, as shown most clearly in the perspective image of FIG. 3C, the fingerprint-shaped pattern after the development is configured with a left PS line Lᵢ and a space Sₚ that is formed by removing the PMMA. Further, the thickness of the line Lᵢ is about 31 nm. That is, the obtained pattern may have a thickness that can sufficiently function as an etching mask for a bottom layer.

In order to arrange the PS region and PMMA region of the PS-b-PMMA in a desired pattern (i.e., circuit pattern), a guide pattern is formed on a surface of the substrate with the PS-b-PMMA applied thereon. However, in the present embodiment, the PS-b-PMMA is applied without forming the guide pattern. Therefore, as shown in FIG. 3C, the fingerprint-shaped pattern is formed. Although the pattern has a fingerprint shape, the width of a line (left PS region) and the width of a space (removed PMMA region) are almost constant in the pattern. This, as described above, is because the widths are respectively determined with the molecular lengths of PS and PMMA.

### Second Embodiment

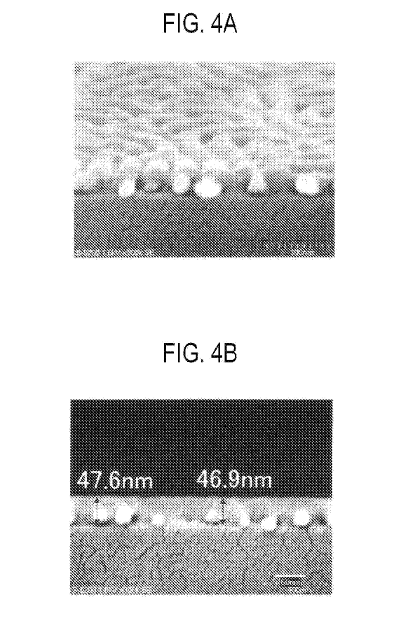

Next, similarly to the first embodiment, FIGS. 4A and 4B show the result obtained by forming a PS-b-PMMA layer, heating the formed PS-b-PMMA layer, exposing the heated PS-b-PMMA layer with a Xe excimer lamp (having a light emission wavelength of about 172 nm) instead of a low-pressure mercury lamp, and developing the exposed PS-b-PMMA layer with TMAH. As shown in a perspective image of FIG. 4A and a sectional image of FIG. 4B, even when a Xe excimer lamp is used, it can be seen that a fingerprint-shaped pattern is formed.

As described above, according to a pattern forming method of the first embodiment, a phase separation is performed by heating a PS-b-PMMA layer, the PS-b-PMMA layer of which a PS region and a PMMA region are regularly arranged is exposed with UV light, and the exposed layer is developed with a developing solution, thereby forming a pattern with the PS region as a line. Since the exposure using the UV light, for example, may be performed with the low-pressure mercury lamp or the excimer lamp in the atmosphere, a large-scale device is not required. Further, since the development may be performed with the developing solution, the development can be performed without greatly changing existing equipment, and thus, a simple pattern forming method can be provided at low cost. Moreover, the PS region has a resistance to the exposure using the UV light and the development using the developing solution, thereby obtaining a pattern having a sufficient thickness for use of the pattern as an etching mask.

### <Second Aspect>

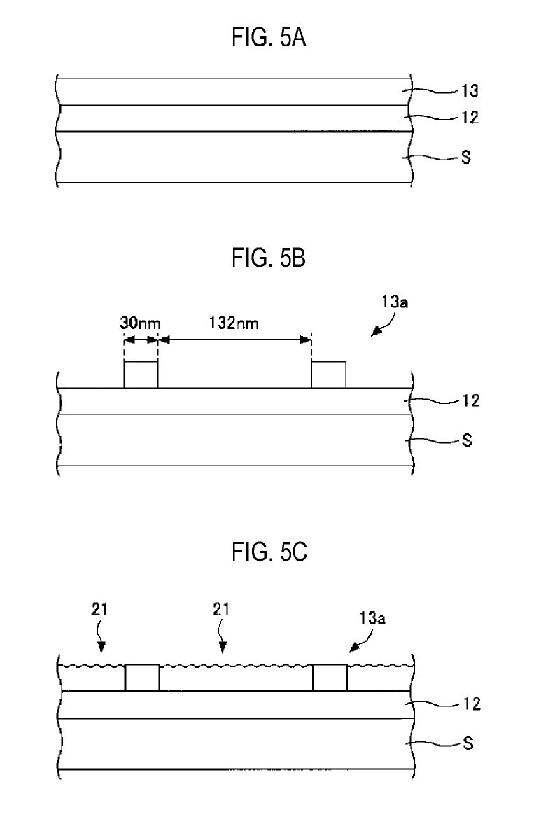

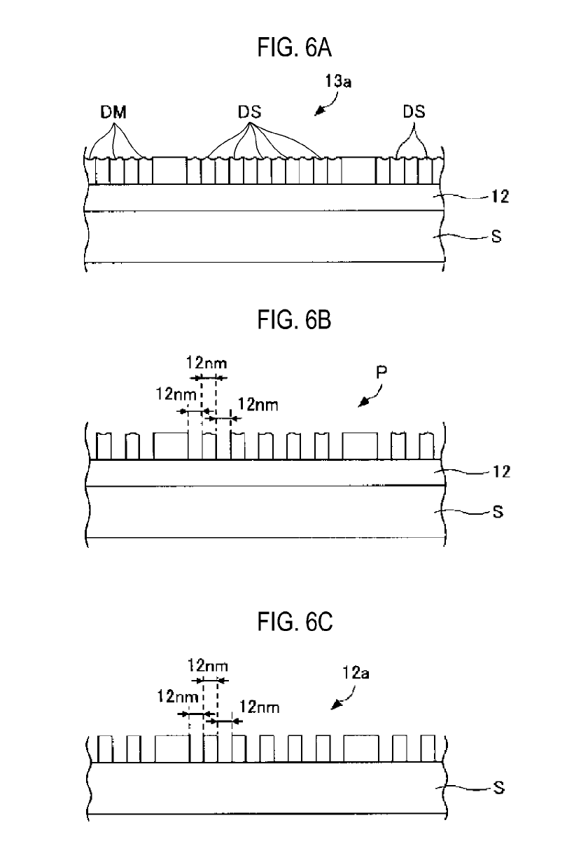

Next, a pattern forming method according to a second aspect of the present disclosure, for example, a case that manufactures an etching mask having a line•and•space•pattern of which a line width and a space width are about 12 nm, will now be described with reference to FIGS. 5A to 6C.

Referring to FIG. 5A, a thin layer 12 and a photoresist layer 13 are sequentially stacked on a substrate S. The substrate S may be a semiconductor (for example, silicon) substrate or a substrate where a conductive layer corresponding to a semiconductor element or a wiring and an insulation layer for insulating the semiconductor element or the wiring are formed.

The thin layer 12 is intended to be etched. For example, the thin layer 12 may be formed by depositing an insulation layer such as oxide silicon (SiO), nitride silicon (SiN), or oxynitride silicon (SiNO), and a conductive layer such as amorphous silicon (α-Si) or poly silicon (poly-Si) in a vapor deposition process. In the present aspect, the thin layer 12 is formed of SiN. In addition, the thickness of the thin film 12 may be, for example, about 20 nm to about 200 nm.

The photoresist layer 13 formed by applying a negative electron ray resist, having sensitivity to an electron ray, on the thin film 12.

Subsequently, the photoresist layer 13 is exposed by irradiating an electron ray thereon through a photomask having a desired pattern and the exposed photoresist layer 13 is developed with an organic solvent, and thus, as illustrated in FIG. 5B, a photoresist pattern 13a is obtained. In the present aspect, the photoresist pattern 13a may have, for example, a line width of about 30 nm and a space width of about 132 nm.

Referring to FIG. 5C, the space of the photoresist pattern 13a is filled with a PS-b-PMMA block copolymer layer 21. The PS-b-PMMA layer 21 is formed by applying a coating solution of PS-b-PMMA onto the substrate S where the photoresist pattern 13a is formed on the thin layer 12. A PS polymer and a PMMA polymer are mixed with each other in the PS-b-PMMA layer 21 after the application.

Subsequently, by heating the substrate S, the PS-b-PMMA is phase-separated, and, as schematically illustrated in FIG. 6A, a PS region DS and a PMMA region DM are formed in the PS-b-PMMA layer 21. As illustrated in FIG. 6A, the PMMA region DM and the PS region DS are alternately arranged inside the space of the photoresist pattern 13a. Such an arrangement is auto-systematically realized with the property that a PMMA polymer adsorbs preferentially to a side wall of a photoresist pattern having hydrophilicity. Further, in the present embodiment, the PMMA region DM and the PS region DS, which are arranged inside the space, have a width of about 12 nm. This is realized by adjusting the degree of polymerization of a PMMA polymer and PS polymer in a coating solution.

Then, as described in the first aspect and the first embodiment, by performing an exposure using UV light and development using TMAH, as illustrated in FIG. 6B, the PS region DS remains. The width of the PS region DS and the width of the PMMA region DM, as described above, were about 12 nm, and thus, a line•and•space•pattern P having a line width of about 12 nm and a space width of about 12 nm is formed. In addition, when the PS-b-PMMA after the exposure is developed with TMAH, the photoresist pattern 13a formed of an electron ray resist is negligibly dissolved in the TMAH because of a tolerance to the TMAH.

Subsequently, by etching the thin layer 12 with the line-and-space-pattern P as an etching mask, as illustrated in FIG. 6C, a thin layer 12a that is patterned by a pattern having a line width of about 30 nm and a space width of about 132 nm and a pattern having a line width of about 12 nm and a space width of about 12 nm in the said space width of about 132 nm is obtained.

According to the present aspect, by applying an electron ray resist and exposing the applied resist with an electron ray, the photoresist pattern 13a is formed. Then by applying a coating solution of PS-b-PMMA, heating, exposing with UV light, and developing with TMAH, the line•and•space pattern P, which is hardly realized even by exposing a photoresist layer with an electron ray, having a line width of about 12 nm and a space width of about 12 nm is formed. The width of a line, which is determined by the PS region DS formed in the photoresist pattern 13a, is determined by the molecular length of PS, and thus, Line Width Roughness (LWR) can be reduced.

### <Third Aspect>

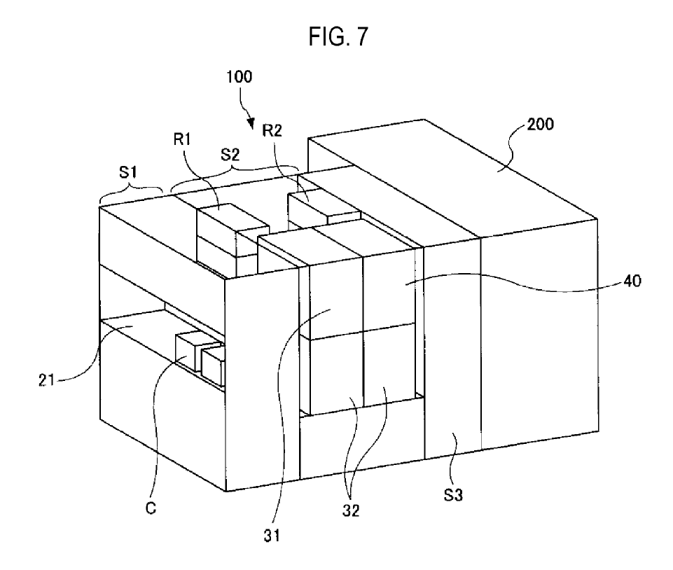

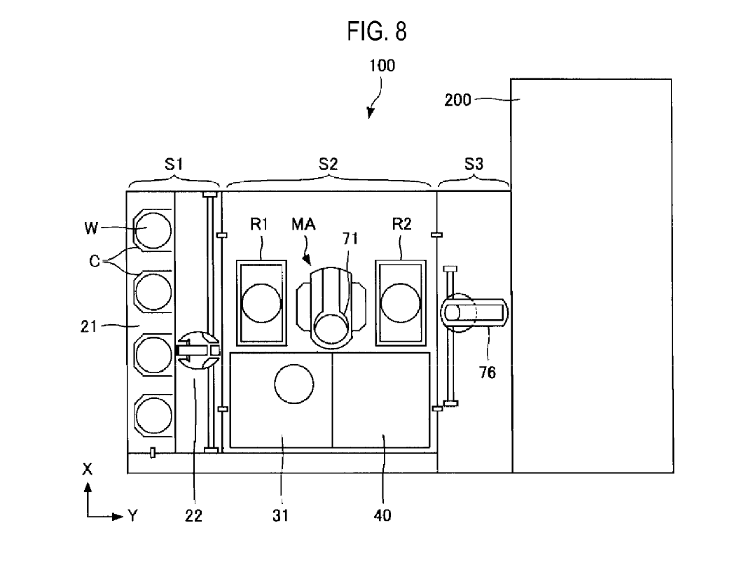

Next, a pattern forming device according to a third aspect of the present disclosure, which is suitable for performing the pattern forming method according to the first aspect and the pattern forming method according to the second aspect, will now be described in detail with reference to FIGS. 7 to 10. FIG. 7 is a schematic perspective view illustrating a pattern forming device 100 according to the present aspect. FIG. 8 is a schematic top view illustrating the pattern forming device 100. As illustrated in FIGS. 7 and 8, the pattern forming device 100 includes a cassette station 51, a processing station S2, and an interface station S3.

In the cassette station 51, a cassette stage 21 and a transfer arm 22 (see FIG. 8) are installed. A wafer cassette C (hereinafter referred to as a cassette) capable of receiving a plurality of (for example, 25) semiconductor wafers W (hereinafter referred to as a wafer) therein is disposed in the cassette stage 21. As illustrated in FIG. 8, in the present aspect, four cassettes C may be arranged in the cassette stage 21. In the following description, for convenience, the direction in which the cassettes C are arranged is assumed as the X direction, and the direction perpendicular to the X direction is assumed as the Y direction. In order to transfer the wafer W between the cassette C disposed on the cassette stage 21 and the processing station S2, the transfer arm 22 is ascendable, descendable, movable in the X direction, extendable in the Y direction, and rotatable about a perpendicular axis.

The processing station S2 is coupled to a +Y direction side with respect to the cassette station 51. In the processing station S2, two application units 32 are disposed along the Y direction, and a development unit 31 and a UV irradiation unit 40 are sequentially disposed on the application units 32 in the Y direction. Referring to FIG. 8, a rack unit R1 is disposed in an X direction side with respect to the application unit 32 and development unit 31, and a rack unit R2 is disposed in an X direction side with respect to the application unit 32 and the UV irradiation unit 40. A processing unit (not shown), which responds to processing performed on a wafer, as described below, is stacked on each of the rack units R1 and R2. In the approximate center of the processing station S2, a main transfer apparatus MA (see FIG. 8) is disposed, and the main transfer apparatus MA has an arm 71. In order to access the application unit 32, the development unit 31, the UV irradiation unit 40, and each of the processing units of the rack units R1 and R2, the arm 71 is ascendable, descendable, movable in the X direction and the Y direction, and rotatable about a perpendicular axis.

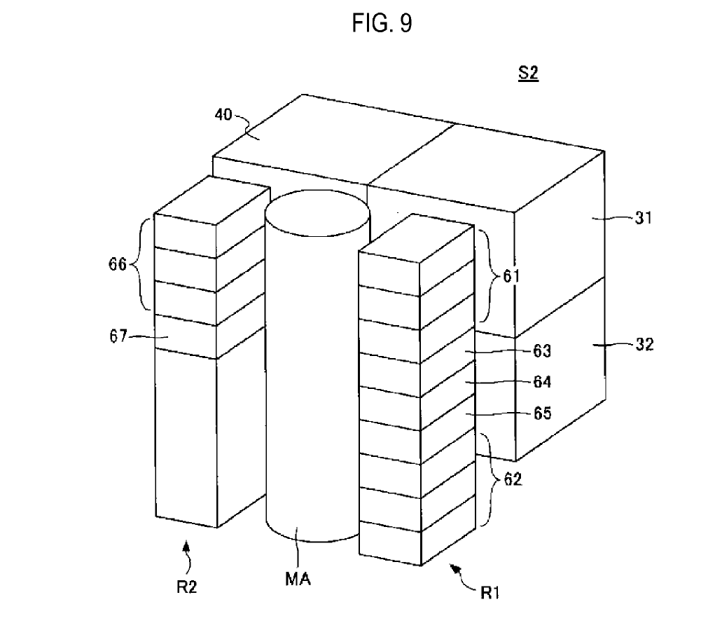

As illustrated in FIG. 9, a heating unit 61 that heats the wafers W, a chilling unit 62 that chills the wafers W, a hydrophobic unit 63 that makes a wafer surface hydrophobic, a pass unit 64 having a stage on which the wafers W are temporarily disposed, and an alignment unit 65 that aligns the positions of the wafers W are arranged on the rack unit R1 in a height direction. In addition, a plurality of Chilling Hot Plate (CHP) units 66 (CHP processing station) that heat and then chill the wafers W, and a pass unit 67 having a stage on which the wafers W are temporarily disposed are arranged on the rack unit R2 in a height direction. However, in the rack units R1 and R2, the type and arrangement of each unit are not limited to that shown in FIG. 9, and may be varyingly changed.

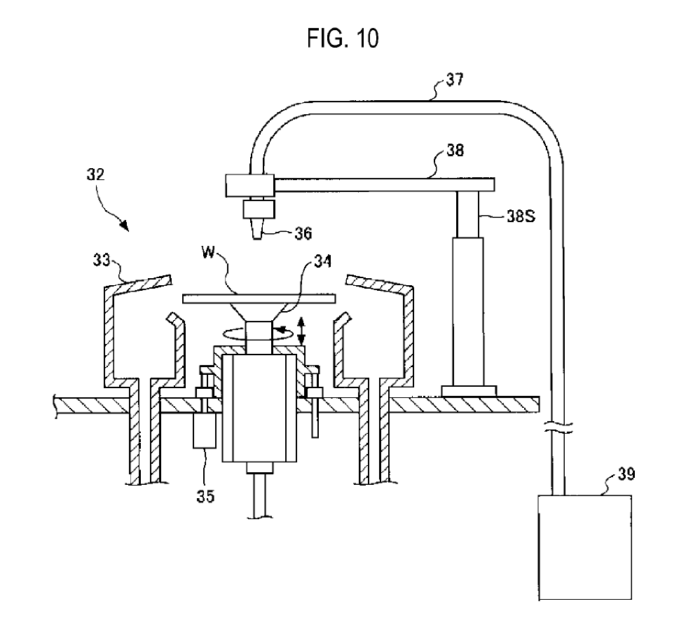

Next, the application unit 32 will now be described in detail with reference to FIG. 10. As illustrated in FIG. 10, the application unit 32 includes: a spin chuck 34, which adsorbs, retains, and supports the wafers W, and is vertically movable and rotatable by a driving apparatus 35; a solution supply nozzle 38, which supplies a coating solution on the wafers W that are retained and supported by the spin chuck 34; and a cup 33, which is disposed around the wafers W that are retained and supported by the spin chuck 34, and receives the coating solution that is supplied onto the wafers W and scattered from the surfaces of the wafers W by rotation. The solution supply nozzle 38 is rotatable by a support shaft 38S, and a front end portion 36 of the solution supply nozzle 38 may be moved to be disposed at a certain position (home position) of an outer side of the cup 33 and a center upper position (supply position) of the wafer W that is retained and supported by the spin chuck 34. One end portion of a coating solution supply tube 37 is connected to the front end portion 36, and the other end portion of the coating solution supply tube 37 is connected to a solution tank 39. For example, a solution (coating solution) that is produced by dissolving PS-b-PMMA in an organic solvent is stored in the solution tank 39.

In a state where the front end portion 36 of the solution supply nozzle 38 is disposed at the home position, when the arm 71 of the main transfer apparatus MA (see FIG. 8) carries the wafer W to the upper portion of the spin chuck 34, the spin chuck 34 is moved upwards by the driving apparatus 35 and receives the wafer W from the arm 71. The arm 71 withdraws from the spin chuck 34, and then the spin chuck 34 is moved downwards by the driving apparatus 35, whereby the wafer W is placed in the cup 33. The wafer W is rotated at a certain rotation speed by the spin chuck 34, and simultaneously, the front end portion 36 of the solution supply nozzle 38 rotates from the home position to the supply position and supplies the coating solution, which is supplied through the coating solution supply tube 37, onto the wafer W. Therefore, a block copolymer layer is formed on the wafer W.

Moreover, when the wafer W is rotated by the spin chuck 34, the rotation speed of the wafer W can be changed appropriately according to the step that supplies the coating solution onto the wafer W, the step that broadens the coating solution to have a certain layer thickness, and the step that dries the coating solution similarly to the step in the case that supplies a photoresist solution onto the wafer W to form a photoresist layer.

Moreover, in the pattern forming device 100 according to the present aspect, one of the two application units 32 may be used to form a block copolymer layer, and the other may be used to form a photoresist layer. In addition, two solution supply nozzles 38 may be installed in the application unit 32. One of the two solution supply nozzles 38 may be used to supply a coating solution in connection with the solution tank 39, and the other of the two solution supply nozzles 38 may be used to supply a photoresist solution to a photoresist tank (not shown). In the present aspect, as also described above in the second aspect, the photoresist solution is an electron ray photoresist.

The development unit 31 has the same configuration as that of the application unit 32, except that a developing solution (for example, TMAH) is stored in the solution tank 39 and supplied. Thus, a description of the development unit 31 is not provided.

Referring again to FIGS. 7 and 8, the interface station S3 is coupled to a +Y direction side of the processing station S2, and an exposure device 200 is coupled to a +Y direction side of the interface station S3. A transfer apparatus 76 (see FIG. 8) is disposed in the interface station S3. In order to carry the wafer W between the exposure apparatus 200 and the pass unit 67 (see FIG. 9) of the rack unit R2 in the processing station S2, the transfer apparatus 76 is ascendable, descendable, movable in the X direction, extendable in the Y direction, and rotatable about a perpendicular axis.

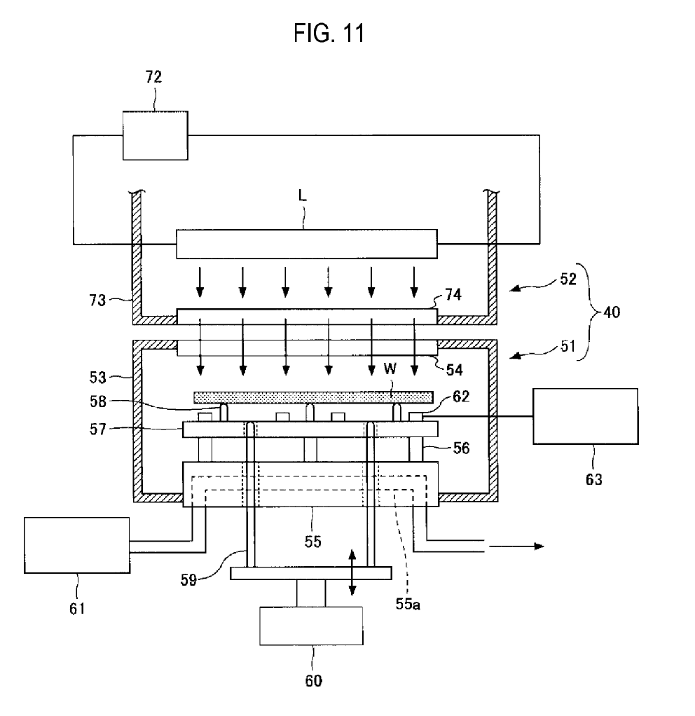

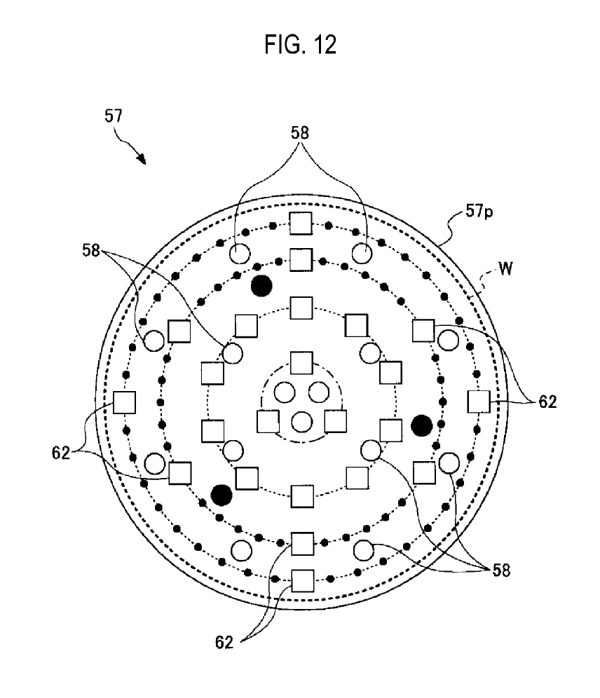

Next, the UV irradiation unit 40 will now be described in detail with reference to FIGS. 11 and 12. FIG. 11 is a schematical side-sectional view illustrating the UV irradiation unit 40. As illustrated in FIG. 11, the UV irradiation unit 40 includes a wafer chamber 51 in which the wafer W is placed, and a light source chamber 52 that irradiates UV light on the wafer W which is placed in the wafer chamber 51.

The wafer chamber 51 includes a housing 53, a transmission window 54 that is disposed at a ceiling portion of the housing 53 and transmits UV light, and a susceptor 57 on which the wafer W is disposed. The transmission window 54, for example, may be formed of quartz glass. The susceptor 57, as illustrated in FIG. 12, includes a discal plate 57p, a plurality of light emitting elements 62 that are disposed at a surface of the plate 57p and emit, for example, infrared light (or far-infrared light), and a plurality of support pins 58 that are disposed at the surface of the plate 57p and support the wafer W. The discal plate 57p has a diameter equal to or slightly greater than that of the wafer W, and preferably, is formed of a material having high heat conductivity, for example, silicon carbide (SiC) or aluminum.

The light emitting elements 62, powered by a power source 63 (see FIG. 11), emit infrared light (or far-infrared light), and thus, heat the wafer W that is supported by the support pins 58. The light emitting elements 62, as illustrated in FIG. 12, are disposed at certain intervals on the circumferences of a plurality of concentric circles on the plate 57p. For example, it is preferable to determine the arrangement of the light emitting elements 62 with a computer simulation such that the wafer W is uniformly heated. Further, in order to monitor the temperature of the wafer W and maintain the wafer W at a certain temperature, for example, a radiation thermometer (not shown) and a temperature adjustor (not shown) may be installed.

The plurality of support pins 58 prevent the wafer W from being excessively heated and facilitate the chilling of the wafer W after heating. Therefore, the support pins 58 may be formed of a material having a high heat conductivity greater than or equal to 100 W/(m·k), for example, silicon carbide (SiC). Additionally, in an illustrated example, the support pins 58 are disposed on the circumferences of approximate three concentric circles on the plate 57p. In order to facilitate heat conduction from the wafer W to the susceptor 57, the number of support pins 58 is not limited to the illustrated example, and more support pins than the number of illustrated support pins 58 may be installed.

As illustrated in FIG. 11, a water flow path 55a of cooling water is formed inside a base plate 55. A cooling water supply device 61 supplies cooling water into the water flow path 55a, and thus, the entirety of the base plate 55 is chilled at a certain temperature. A supporter 56 that is installed on the base plate 55 and supports the susceptor 57 may be formed of, for example, aluminum.

Moreover, the wafer chamber 51 includes: ascent/descent pins 59 that ascends/descends through the base plate 55 and the susceptor 57 such that they supports the wafer W from thereunder to lift/drop the wafer W when carrying in/out the wafer W; and an ascent/descent apparatus 60 that lifts/drops the ascent/descent pins 59. Further, a transfer entrance (not shown) is formed in the wafer chamber 51 such that the wafer W is carried into the wafer chamber 51 by the arm 71 of the main transfer apparatus MA, and carried out of the wafer chamber 51 therethrough. In addition, for example, a gate valve (not shown) is installed in the transfer entrance such that the transfer entrance is opened or closed by the gate valve.

The light source chamber 52, which is disposed over the wafer chamber 51, includes the UV light source L that irradiates UV light, and a power source 72 that supplies power to the light source L. The light source L is placed in the housing 73. As described above, the light source L may be configured with, for example, a low-pressure mercury lamp or an excimer lamp. Specifically, in the light source L, a plurality of low-pressure mercury lamps or a plurality of excimer lamps may be installed in parallel. An irradiation window 74 is installed at a bottom portion of the housing 73 for transmitting UV light emitted from the light source L to the wafer chamber 51. The irradiation window 74 may be formed of, for example, quartz glass. The UV light emitted from the light source L is radiated toward the wafer chamber 51 through the irradiation window 74, and transmitted through the transmission window 54 of the wafer chamber 51 to irradiate the wafer W.

In the UV irradiation unit 40 having the above-described configuration, the PS-b-PMMA layer that is formed on the wafer W by the application unit 32 is exposed and developed as described below. That is, the wafer W with the PS-b-PMMA layer formed thereon is loaded into the wafer chamber 51 by the arm 71 of the main transfer apparatus MA, received by the ascent/descent pins 59, and disposed on the support pins 58 on the susceptor 57. Subsequently, the light emitting elements 62 of the susceptor 57 are powered such that infrared light (or far-infrared light) is emitted from the light emitting elements 62, whereby the wafer W is heated to a certain temperature. After a certain time elapses, when the power supply to the light emitting elements 62 is stopped, the heat of the wafer W is transferred to the base plate 55 through the support pins 58 and the plate 57p, and the wafer W is chilled, for example, to a room temperature (about 23 degrees C.).

After the temperature of the wafer W becomes approximately room temperature, the light source L is powered by the power source 72, and UV light is emitted from the light source L. The UV light is irradiated on a surface of the wafer W through the irradiation window 74 of the light source chamber 52 and the transmission window 54 of the wafer chamber 51. Since a dose of UV light is determined as “intensity of illumination×irradiation time,” the dose of UV light necessary for exposure of the PS-b-PMMA layer may be calculated previously, and the irradiation time may be determined with the intensity of illumination of the UV light. For example, the irradiation time may be several seconds to several minutes.

After the UV light is irradiated for a certain time, the wafer W is carried out from the UV irradiation unit 40 in reverse order to when the wafer W is carried in. Subsequently, the wafer W is transferred to the development unit 31. Herein, for example, the PS-b-PMMA layer is developed, and a pattern configured with a PS region is obtained.

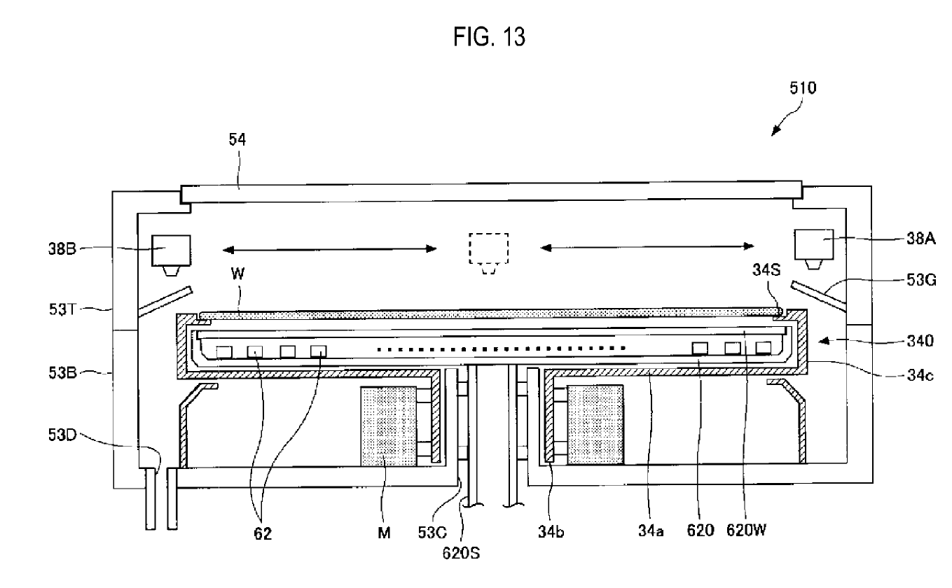

Next, a modified embodiment of the UV irradiation unit 40 will now be described in detail with reference to FIG. 13. Compared with the UV irradiation unit 40, in the UV irradiation unit according to the modified embodiment, the wafer chamber is different from that of the UV irradiation unit 40, and the light source chamber 52 is the same as that of the UV irradiation unit 40. Therefore, the following description will only focus on the wafer chamber.

Referring to FIG. 13, a wafer chamber 510 of the UV irradiation unit of the modified embodiment includes a top housing 53T and a bottom housing 53B. The top housing 53T is disposed at a top border of the bottom housing 53B by a seal member (for example, an O ring, not shown), and the top housing 53T and the bottom housing 53B are sealed by the seal member. The top housing 53T is capable of upwardly moving together with the light source chamber 52, which is disposed over the top housing 53T, and when the top housing 53T is moved upward, a wafer is carried into the wafer chamber 510. A guide member 53G that has a ring shape and is inclined toward an inner circumference of the top housing 53T is disposed at the inner circumference of the top housing 53T. The guide member 53G guides a coating solution or a developing solution (described below), which is supplied to the wafer W and scattered by the rotation of the wafer W, to the bottom housing 53B. Moreover, the coating solution or developing solution guided to the bottom housing 53B is discharged through a discharge outlet 53D that is formed at a bottom portion of the bottom housing 53B.

A wafer rotation part 340, which supports and rotates the wafer W, and a driving part M, which rotates the wafer rotation part 340, are installed in the bottom housing 53B. The wafer rotation part 340 includes: a ring-shaped plate member 34a that has an opening at a center portion thereof; a hollow and cylindrical base portion 34b that is disposed at an opening of the center portion of the rear surface of the plate member 34a; and a cylindrical circumference portion 34c that extends upwardly from an outer circumference of the plate member 34a. The circumference portion 34c has an inner diameter slightly greater than an outer diameter of the wafer W, and a hook portion 34S that extends from the circumference portion 34c to the inside the circumference portion 34c is installed at an upper portion of the circumference portion 34c. In the present aspect, twelve hook portions 34S are disposed at certain intervals in the circumference portion 34c. The hook portions 34S contact a rear-surface peripheral edge of the wafer W such that the wafer W is supported thereby. Further, the hook portions 34S may be formed to move vertically, for example, in order to receive the wafer W by the arm 71 of the main transfer apparatus MA.

The driving part M is disposed on a bottom portion of the bottom housing 53B to surround the base portion 34b of the wafer rotation part 340. The driving part M retains and supports the base portion 34b rotatably, thereby rotating the wafer rotation part 340 and the wafer W that is supported by the wafer rotation part 340.

An opening is formed at the bottom center of the bottom housing 53B, and a cylindrical member 53C is disposed in the opening. A support member 620S is inserted into an interior space of the cylindrical member 53C, and is fixed to an inner surface of the cylindrical member 53C by a certain member. A heating part 620 is disposed at an upper end portion of the support member 620S. The heating part 620 has an outer diameter slightly greater than or equal to that of the wafer W. Further, the heating part 620 has a cylindrical shape having a flat bottom, and a plurality of light emitting elements 62 is disposed at a bottom of the heating part 620. A power source (corresponding to the power source 63, not shown) is connected to the light emitting elements 62. A transmission window 620W that transmits infrared light (or far-infrared light) is disposed at an upper end portion of the heating part 620.

Moreover, a coating solution supply nozzle 38A that supplies a coating solution of a block copolymer (PS-b-PMMA) and a developing solution supply nozzle 38B that supplies a developing solution (for example, TMAH) to the wafer W supported by the wafer rotation part 340 are disposed in the wafer chamber 510. The coating solution supply nozzle 38A and the developing solution supply nozzle 38B are configured similarly to the solution supply nozzle 38 of FIG. 10, and moves back and forth between a home position (the position of each of the nozzles 38A and 38B illustrated by solid lines in FIG. 13) outside the circumference of the wafer W and a supply position (the position of each of the nozzles 38A and 38B illustrated as a broken line in FIG. 13) over the center of the wafer W.

According to the above-described configuration, when the top housing 53T and the light source chamber 52 are moved upward, for example, the wafer W is carried into the wafer chamber 510 by the arm 71 of the main transfer apparatus MA and received by the wafer rotation part 340. Then, the upper housing 53T and the light source chamber 52 descend and are disposed at an upper border of the bottom housing 53B. The wafer rotation part 340 and the wafer W are rotated by the driving part M and simultaneously the coating solution supply nozzle 38A moves from the home position to the supply position to supply a coating solution onto the wafer W, whereupon the coating solution supply nozzle 38A returns to the home position. Then the coating solution on the wafer W is spread to a certain thickness by rotation, a block copolymer layer is formed, and the wafer rotation part 340 stops.

Subsequently, the light emitting elements 62 are powered such that infrared light (or far-infrared light) from the light emitting elements 62 is irradiated on the wafer W, whereby the wafer W is heated to a certain temperature. After a certain time elapses, the power supply to the light emitting element 62 is stopped. By the heating, a PS region and a PMMA region are arranged inside the block copolymer layer.

Then, the light source L of the light source chamber 52 is powered by the power source 72 (see FIG. 11) such that UV light from the light source L is irradiated on the wafer W for a certain time. Therefore, the block copolymer layer is exposed.

Subsequently, the developing solution supply nozzle 38B moves from the home position to the supply position and supplies the developing solution onto the wafer W. The supplied developing solution spreads over an entire surface of the wafer W, and remains on the surface of the wafer W at a certain thickness by surface tension. The PMMA region is dissolved by the developing solution remaining on the surface of the wafer W such that the block copolymer is developed (patterned). Thereafter, the wafer W is rotated by the wafer rotation part 340, and thus, the developing solution remaining on the surface of the wafer W is removed, and simultaneously a rinsing solution is supplied from a rinsing solution supply nozzle (not shown), whereby the surface of the wafer W is cleaned. Moreover, a chilling apparatus (not shown) may be disposed adjacent to the wafer chamber 510 such that after the wafer W is heated, the wafer W may be carried into the chilling apparatus by lifting the top housing 53T, whereupon the wafer W may be chilled in the chilling apparatus.

As described above, the UV irradiation unit of the modified embodiment has an advantage in that a series of processes such as formation, exposure, and development of the block copolymer are performed.

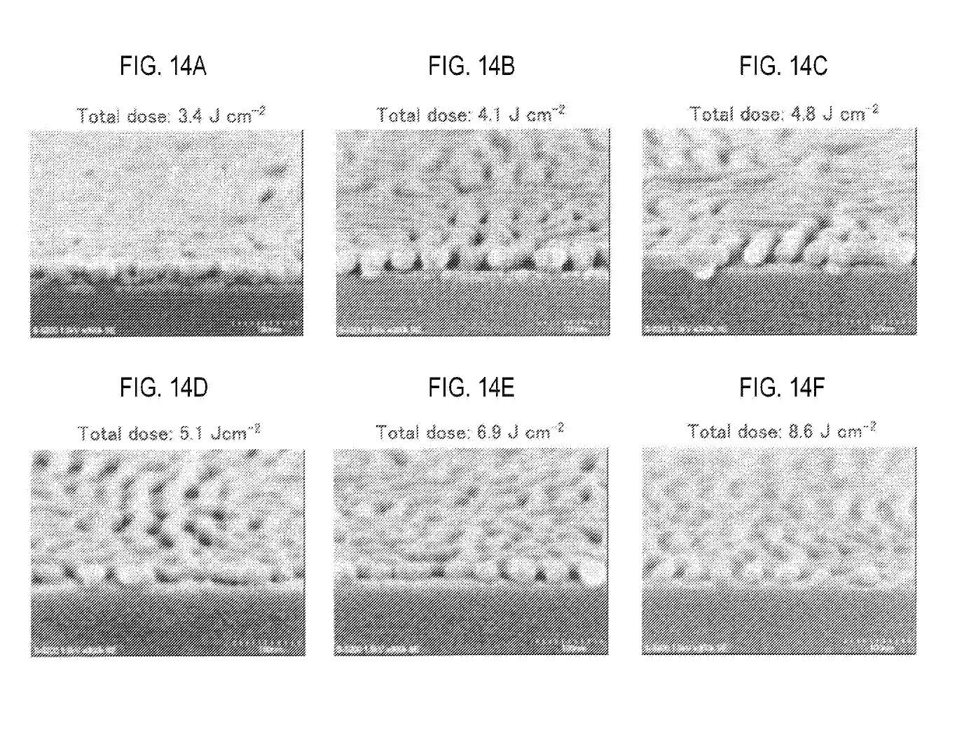

An experiment that has been performed on how much a pattern (PS region) formed of PS-b-PMMA is dependent on a dose of UV light and the experiment results will now be described. In the experiment, similarly to the above-described first embodiment, on six substrates, six samples were produced by forming and heating a PS-b-PMMA layer, the PS-b-PMMA layer was exposed using a low-pressure mercury lamp in corresponding six doses, and the exposed PS-b-PMMA layer was developed with TMAH (2.38%). Such results are shown in FIGS. 14A to 14F. As shown in FIGS. 14A to 14F, it can be seen that a good pattern has been formed in a dose (a peak of a wavelength of 254 nm of UV light from the low-pressure mercury lamp) within a range from about 4.1 J/cm² to about 5.1 J/cm². In addition, when the dose is less than that range, a PMMA region after the exposure is not sufficiently removed with the TMAH, and when the dose is greater than that range, for example, the dose is about 6.9 J/cm² or about 8.6 J/cm², a left PS region becomes thinner in thickness. Considering the results of the above-described first embodiment, when the PS-b-PMMA layer is exposed with the low-pressure mercury lamp, a dose within a range from about 4.0 J/cm² to about 5.5 J/cm² can be considered to be preferable.

Converting the range into a dose in a peak of a wavelength of 185 nm of the UV light from the low-pressure mercury lamp, since the intensity of the peak of the wavelength of 185 nm is approximate one-hundredth of the intensity of a peak of a wavelength of 254 nm, the range is from about 40 mJ/cm² to about 55 mJ/cm².

In the above description, the present disclosure has been described with reference to some aspects and embodiments, but the present disclosure is not limited to the above-described aspects and embodiments. The present disclosure may be varyingly modified or changed without departing from the spirit and scope thereof as defined by the appended claims.

For example, a developing solution for developing a block copolymer (PS-b-PMMA) after the exposure is not limited to TMAH, and a developing solution including potassium hydroxide may be used. Further, the block copolymer (PS-b-PMMA) after the exposure may be developed with a mixed solution of methyl isobutyl ketone (MIBK) and IPA mixed liquid.

In the third aspect, although the light emitting elements 62 are included in the susceptor 57 (heating part 620 in the modified embodiment), the susceptor 57 (heating part 620) may include an electric heater instead of the light emitting elements 62 to heat the wafer W with the block copolymer layer formed thereon. Further, a fluid flow path may be formed in the susceptor 57, and by flowing a temperature-adjusted fluid through in the fluid flow path, the wafer W on the susceptor 57 may be heated. In addition, the light emitting elements 62 may be disposed in the light source chamber 52 instead of the susceptor 57 (heating part 620), and irradiate infrared light (or far-infrared light) on the wafer W through the irradiation window 74 and the transmission window 54. An infrared lamp may be installed in the light source chamber 52. A light emitting element or an infrared lamp may be disposed in the light source L.

The description of the third aspect has been made above in the case where the wafer W is heated by the light emitting element 62 on the susceptor 57 of the wafer chamber 51 and then chilled to a room temperature, whereupon the UV light from the light source L is irradiated on the wafer W. However, the UV light may be irradiated on the heated wafer W. In addition, when the temperature of the wafer W is falling, the UV light may be irradiated on the wafer W.

Moreover, an oxygen gas supply pipe, for example, a supply pipe (which bubbles pure water with nitrogen gas or uncontaminated air to supply vapor) may be installed in the wafer chamber 51 to adjust a concentration or humidity of oxygen in the atmosphere inside the wafer chamber 51.

Moreover, the heating unit 61 or CHP unit 66 of the pattern forming device 100 may be used to heat the block copolymer (PS-b-PMMA) layer in the first and second aspects.

When an excimer lamp is used as the light source L of the UV irradiation unit 40 or 400 in the third aspect, a plurality of Xe excimer lamps (having a light emission wavelength of about 172 nm) and a plurality of KrCl excimer lamps (having a light emission wavelength of about 222 nm) may be alternately installed in parallel. In this case, the Xe excimer lamps and the KrCl excimer lamps may emit light simultaneously or alternately. UV light having a wavelength of 172 nm is easily absorbed into the atmosphere, and thus, even when the UV light is transmitted in the atmosphere by a distance of, for example, about 5 mm, the intensity of the UV light is attenuated by about 10%. Therefore, when a Xe excimer lamp is used, the distance D (see FIG. 1C) between the Xe excimer lamp and a substrate may be shorter than when a low-pressure mercury lamp is used.

The semiconductor wafer has been exemplified in the above-described aspects, but the present disclosure is not limited thereto. In the present specification, in addition to the semiconductor wafer, for example, a glass substrate for a flat panel display may be used.

According to the embodiments of the present disclosure, provided are a pattern forming method and a pattern forming device that can easily form a pattern with a block copolymer.

While certain embodiments have been described, these embodiments have been presented by way of example only, and are not intended to limit the scope of the disclosures. Indeed, the novel methods and apparatuses described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A pattern forming method comprising:
forming a layer of a block copolymer, comprising at least two kinds of polymers, on a substrate;
heating the block copolymer layer;
irradiating UV light on the heated block copolymer layer; and
supplying a developing solution to the UV light-irradiated block copolymer layer.

2. The pattern forming method of claim 1, wherein in the irradiating of UV light, a low-pressure UV lamp is used as a light source for the UV light.

3. The pattern forming method of claim 1, wherein in the irradiating of UV light, one or both of a Xe excimer lamp and a KrCl excimer lamp is used as a light source for the UV light.

4. The pattern forming method of claim 1, wherein one of the at least two kinds of polymers comprises a ketone group, and the other does not comprise a ketone group.

5. The pattern forming method of claim 1, wherein one of the at least two kinds of polymers is polystyrene, and the other is polymethyl methacrylate.

6. The pattern forming method of claim 1, wherein the developing solution is tetramethyl ammonium hydroxide.

7. A pattern forming device comprising:
a substrate rotation part configured to support a substrate and rotate;
a coating solution supply part configured to supply a coating solution, comprising a block copolymer, to the substrate supported by the substrate rotation part;
a heating part configured to heat the substrate on which a layer of the block copolymer is formed;
a light source configured to irradiate UV light on the heated block copolymer layer;
a developing solution supply part configured to supply a developing solution to the UV light-irradiated block copolymer layer.

8. The pattern forming device of claim 7, wherein the heating part comprises a plurality of light emitting devices configured to emit infrared light or far-infrared light.

9. The pattern forming device of claim 7, wherein the light source comprises a low-pressure UV lamp.

10. The pattern forming device of claim 7, wherein the light source comprises one or both of a Xe excimer lamp and a KrCl excimer lamp.

11. A pattern forming method comprising:
patterning a photoresist layer formed of an electron ray photoresist, and forming a plurality of first lines formed of the electron ray photoresist;
filling a space between the first lines with a layer of a block copolymer comprising at least two kinds of polymers;
heating the block copolymer layer;
irradiating UV light on the heated block copolymer layer; and
supplying a developing solution to the UV light-irradiated block copolymer layer.

12. The pattern forming method of claim 11, wherein in the irradiating of UV light, UV light from a low-pressure UV lamp is irradiated on the block copolymer layer.

13. The pattern forming method of claim 11, wherein in the irradiating of UV light, UV light from one or both of a Xe excimer lamp and a KrCl excimer lamp is irradiated on the block copolymer layer.

14. The pattern forming method of claim 11, wherein one of the at least two kinds of polymers comprises a ketone group, and the other does not comprise a ketone group.

15. The pattern forming method of claim 11, wherein one of the at least two kinds of polymers is polystyrene, and the other is polymethyl methacrylate.

16. The pattern forming method of claim 11, wherein the developing solution is tetramethyl ammonium hydroxide.
